(19) United States
(12) Patent Application Publication
(10) Pub. No.: US 2006/0248082 A1
(43) Pub. Date: Nov. 2, 2006

(54) Method and an apparatus for securely communicating between a management server and a managed node associated with a dynamic provisioning system

(76) Inventors: Amit Raikar, Sunnyvale, CA (US); John Diamant, Fort Collins, CO (US); Todd Spencer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,089

(22) Filed: Apr. 29, 2005

(51) Int. Cl. G06F 17/30; G06F 7/00

(52) U.S. Cl. 707/9

(57) ABSTRACT

Embodiments of the present invention pertain to a method and an apparatus are described. In one embodiment, an initial authentication credential is associated with a management server and a node managed by the management server where the managed node can be provisioned by a dynamic provisioning system. An active authentication credential is generated. The initial authentication credential is used to create a secure communications channel between the management server and the managed node. The secure communications enables the communication of the active authentication credential between the management server and the managed node.

### TECHNICAL FIELD

Embodiments of the present invention relate to secure communications. More specifically, embodiments of the present invention relate to securely communicating between a management server and node managed by the management server.

### BACKGROUND ART

In many corporations, there are various user groups, such as human resources and billing, that use storage and computer cycles to accomplish their assigned tasks. In the past, one way of providing the necessary resources, such as storage and computers, were to hard wire the resources to create a system so that each group had their own assigned computers and storage to accomplish their tasks. However, as time went on, it became evident that the various groups performed their tasks at different times and, therefore, did not need resources that were constantly assigned solely to particular groups. In other words, computers could be assigned to one group when that group needed computer cycles and then re-assigned (e.g., moved) to another group when that group needed computer cycles. This led to dynamic provisioning systems that could dynamically assign resources to one group and then dynamically re-assign those resources to another group as needed. Assigning and re-assigning resources are examples of provisioning and/or re-provisioning resources.

Resources are also known as “nodes.” Examples of a node include a computer with an operating system or a device, such as a router, a firewall, a load balancer, a Quality of Service (QOS) System, a Storage Area Network (SAN) switch, a Local Area Network (LAN) switch, etc.. In one type of dynamic provisioning system, the nodes can be managed by a management server and therefore are referred to as “managed nodes.”

Examples of a management server “managing” a node include, among other things, monitoring the node and/or causing actions to be performed remotely on the node. Examples of monitoring the node include, among other things, determining whether the node or software residing on the node is running, how much memory a node has, the computer processing unit (CPU) utilization of the node, whether a firewall has been intruded. Examples of taking action can include, among other things, causing software to be installed on a node, adding more memory to a node, re-balancing a workload, and/or terminating reception of communications from a network behind a firewall that has failed or is failing.

In order for the management server to securely manage a node, a secure communications channel could be established based on a trust relationship for communicating information from the managed node to the management server for the purpose of monitoring the managed node or for enabling actions to be performed on the managed node.

In conventional dynamic provisioning systems, proprietary software was used for establishing the trust relationship between a management server and a managed node. Proprietary software leads to a system that is not open where all of the management servers and managed nodes associated with a dynamic provisioning system are required to use the same proprietary software rather than each management server and each managed node being able to use different software for establishing the trust relationship. The proprietary software is also inflexible because the default setting of the proprietary software used the same level of trust for all of the management servers and managed nodes associated with a dynamic provisioning system. Further proprietary software is typically expensive manually intensive to configure, and harder to design and implement securely than reusable standard software.

Therefore, there is a need for a method and a system for providing secure communications between a management server and managed nodes in a dynamic provisioning system that is open, flexible, cost effective, and easy to configure.

### DISCLOSURE OF THE INVENTION

Embodiments of the present invention pertain to a method and an apparatus are described. In one embodiment, an initial authentication credential is associated with a management server and a node managed by the management server where the managed node can be provisioned by a dynamic provisioning system. An active authentication credential is generated. The initial authentication credential is used to create a secure communications channel between the management server and the managed node. The secure communications enables the communication of the active authentication credential between the management server and the managed node.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a block diagram of an exemplary management server for securely communicating with a managed node associated with a dynamic provisioning system, according to embodiments of the present invention.

FIG. 2 is a block diagram of an exemplary software system for providing secure communications between a management server and a managed node, according to embodiments of the present invention.

FIG. 3 depicts a flowchart that is used to describe a method for securely communicating between a management server and a managed node, according to embodiments of the present invention.

FIG. 4 is a block diagram of an exemplary software system for securely communicating between a management server and a managed node using the open SSH™ security technology, according to embodiments of the present invention.

FIG. 5 depicts a flowchart that is used to describe a method for securely communicating between a management server and a managed node, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Software System and Functional Overviews

Frequently, in the context of a dynamic provisioning systems, a management server may cause a node that it manages to perform certain actions. Examples, of action include, among other things, shutting down a managed node, setting up a managed node, installing software on a managed node, configuring a managed node, requesting information about the status of the managed node in order to monitor the managed node. In order to cause the managed node to perform an action, a secure communications channel is frequently used between the management server and the managed node to communicate what action the management server wants the managed node to perform. Similarly, a secure communication channel is frequently used for obtaining information about the managed node in order to monitor the managed node.

According to embodiments of the present invention, secure communications channels are established between management servers and managed nodes. The security of the communications channels can be provided based on authentication credentials. For example, according to one embodiment, a secure communications channel between a management server and a managed node is established based on an initial authentication credential, as will become more evident. According to one embodiment, the same initial authentication credential is used to establish secure communications channels between various management servers and various management nodes associated with an installation. Active authorization credentials can be used for establishing subsequent secure communications channels between management servers and management nodes where a different active authentication credential is used for each secure communications channel between each management server and the associated managed node. Further, the authentication credentials can be re-generated and the new re-generated authentication credential can be used for establishing a new secure communications channel (also known as re-freshing the security of an existing communications channel).

According to another embodiment, trust relationships can be established between various nodes in a system, such as management servers and managed nodes. A trust relationship defines a level of trust between the nodes. For example, assume that a trust relationship x is established between a management server A and a managed node B. Further assume, that another trust relationship y is established between management server A and managed node C. Management server A and managed node B can have a different level of trust than management server A and managed node C. According to still another embodiment, the trust relationship can be used to determine what actions one node can cause to be executed on another node. Similarly, the trust relationship can be used to determine what information a management server can obtain from a managed node for the purpose of monitoring the managed node. Establishing trust relationships with different levels of trust between various management servers and managed nodes prevents a management server from obtaining information the management server is not entitled to and/or prevents the management server from causing an action to be executed when the management server does not have the authority to cause that action. Establishing trust relationships with different levels of trust also prevents one node from imitating another node, as will become more evident.

Continuing the example, management server A may be able to cause actions 1, 2, or 5 to be executed on managed node B based on the trust level x that is between management server A and managed node B. However, management server A may be able to cause actions 1, 3, and 4 to be executed on managed node C based on the trust level y that is between management server A and managed node C.

The trust relationship as well as the level of trust between nodes can be terminated or re-generated, according to one embodiment. More specifically, assume that managed node A was provisioned to an accounting group for the purpose of computing payroll. Then managed node B may be managed by a particular management server, such as management server A. A trust relationship x with an associated level of trust can be established between managed node B and management server A in order to compute payroll. After payroll has been computed, the trust relationship x along with an associated level of trust can be terminated between management server A and managed node B. Managed node B will be available to be re-provisioned to another group, such as a group that tests software. In this case, another trust relationship and level of trust can be established between managed node B and whatever management server is deemed appropriate for managing managed node B while being used for testing software.

According to one embodiment, establishing secure communications channels, establishing trust relationships, as well as establishing new secure communications channels, and establishing new trust relationships, among other things, can be done in a flexible manner, as will become more evident. According to yet another embodiment, proprietary software is not required for establishing secure communications channels, establishing trust relationships, as well as establishing new secure communications channels, and establishing new trust relationships, among other things, thus providing an open solution, as will become more evident.

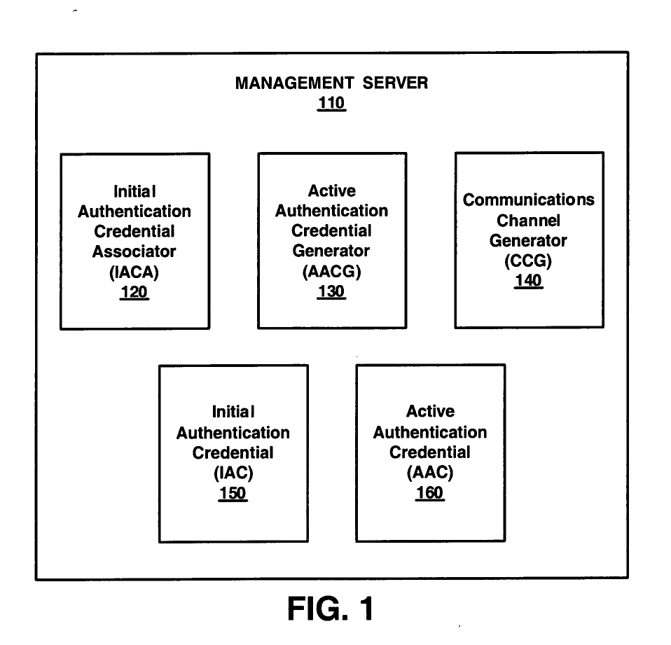

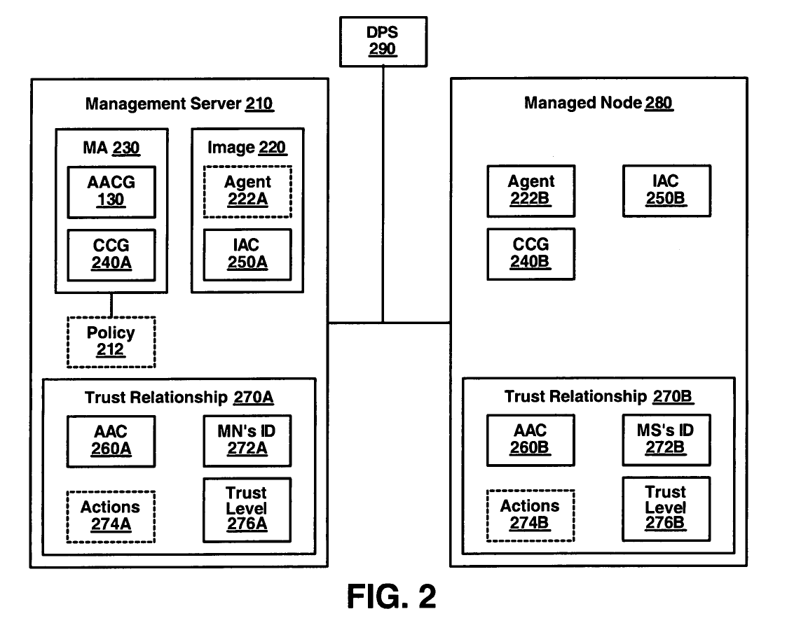

FIG. 1 depicts a block diagram of an exemplary management server for securely communicating with a managed node associated with a dynamic provisioning system, according to embodiments of the present invention. FIG. 2 is a block diagram of an exemplary software system for providing secure communications between a management server and a managed node, according to embodiments of the present invention. The blocks in FIGS. 1 and 2 can be arranged differently than as illustrated, and can implement additional or fewer features than what are described herein. Further, the features represented by the blocks in FIGS. 1 and 2 can be combined in various ways.

FIG. 1 depicts a management server 110 that includes an initial authentication credential associator 120 (IACA), an active authentication credential generator 130 (AACG), a communications channel generator 140 (CCG), an initial authentication credential 150 (IAC) and an active authentication credential 160 (AAC). According to one embodiment, the initial authentication credential associator 120 associates the initial authentication credential 150 with the management server 110 and the active authentication credential generator 130 generates the active authentication credential 160, according to one embodiment, as will become more evident. The communications channel generator (CCG) 140 can generate an initial secure communication channels based on the initial authentication credential 150 and a subsequent secure communications channel based on the active authentication credential 160. According to one embodiment, the initial secure communications channel and the subsequent communications channel are the same communications channel that can be re-freshed with new authentication credentials. For example, the communications channel, which initially is based on an initial authentication credential 150, can be refreshed to be based on an active authentication credential 160 or even refreshed based on regenerated active authentication credentials, as will become more evident.

FIG. 2 depicts a management server 210, a managed node 280 that is managed by the management server 210, and a dynamic provisioning system 290 that can provision and re-provision the managed node 280, as already described herein. The management server 210 includes a management application 230, an image 220, an optional policy 212 and information describing a trust relationship 270A. The management application 230 includes an active authentication credential generator 130 and a communications channel generator 240A. The image 220 includes an optional agent 222A and an initial authentication credential 250A. The information that describes the trust relationship 270A includes an active authentication credential 260A, a managed node's identifier 272A, an optional list of actions 274A, and a trust level 276A.

The image 220 can be an image of an operating system, among other things, that includes, for example, a non-proprietary agent 222A. The information describing trust relationship 270A can use the management node's identifier 272A to indicate what entities the management server 210 has entered into a relationship with. The information describing trust relationship 270A can include a level of trust 276A that has been established between the entities (e.g., the managed node indicated by managed node's identifier 272A) involved in the trust relationship 270A, and actions 274A that the management server 210 can request to be remotely executed on the entity (e.g., the managed node indicated by managed node's identifier 272A).

According to one embodiment, the image 220 is an example of an initial authentication credential associator 120. According to another embodiment, an input device or a generalized user interface (GUI) associated with the computer that the management server 210 executes on are examples of an initial authentication credential associator 120 where the input device or the GUI receives an initial authentication credential 250A and stores it in memory.

The managed node 280 can include an agent 222B, an initial authentication credential 250B, a communications channel generator 240B, and information describing a trust relationship 270B. The information that describes the trust relationship 270B includes an active authentication credential 260B, a management server's identifier 272B, a list of actions 274B, and/or a trust level 275B.

The agent 222B can be a non-proprietary agent that is associated with an operating system that is installed on managed node 280, for example. The information describing trust relationship 270B can use the management server's identifier 272B to indicate what entities the managed node 280 has entered into a relationship with. The information describing trust relationship 270B can include a level of trust 276B that has been established between the entities (e.g., the management server indicated by management server's identifier 272B) involved in the trust relationship 270B, and actions 274B that the managed node 280 will allow to be executed remotely on it (e.g., 280).

The use of proprietary software can be avoided by using, among other things, management application 230 and/or non-proprietary agents 222A, 222B, thus, providing open, flexible, and cost effective secure communications between a management server 210 and a managed node 280. This is made possible by the utility computing infrastructure propagating the secret keys needed to establish trust which can be used by non-proprietary agents in a secure way (out-of-band communication of authentication credentials). Further, a plug and play system is provided since the agent 222A, 222B and/or management application 230 are structured and modular and, therefore, can be easily replaced with different agents 222A, 222B and/or management application 230 respectively.

### Management Server, Managed Node, and Managed System

As already stated herein, a management server 110, 210 can manage a node 280. Examples of a node include, among other things, an operating systems based computer or a device, such as a router, a firewall, a load balancer, a Quality of Service (QOS) System, a Storage Area Network (SAN), a Local Area Network (LAN), etc.. A managed system can include more than one managed node and a management server 110, 210 can manage the managed system.

### Authentication and Authorization

Authentication pertains to a first entity identifying a second entity that requests to communicate with the first entity. For example, if a managed node 280 attempts to communicate with the management server 110, 210, for example, by providing information the management server 110, 210 can use to monitor the managed node 280, the management server 110, 210 can identify the managed node 280. Similarly, if the management server 110, 210 attempts to communicate with a managed node 280, for example, by attempting to cause actions to be performed remotely on the managed node 280, the managed node 280 can identify the management server 110, 210. Examples of identifiers that can be used as a part of authentication include, but are not limited to, a universally unique identifier (UUID) in the case of a LAN switch, a media access control (MAC) address in the case of a device, a world wide identifier (WWID) in the case of a SAN switch, etc..

There can be different levels of confidence with which an entity is identified (e.g., authenticated). For example, assume that a first entity receives a packet that includes a MAC or Internet Protocol (IP) address from a second entity. An example of weak authentication would involve the first entity identifying the second entity merely on the basis of the MAC or IP address in the packet. An example of strong authentication would involve the first entity determining that the second entity really is the entity that it claimed to be.

Authorization pertains to a first entity determining what a second entity is allowed to do with regards to the first entity. For example, a management server 110, 210 can request information from a managed node 280 and allow the managed node 280 to provide the information to a management server 110, 210 for the purposes of monitoring the managed node 280. Similarly, a managed node 280 can allow a management server 110, 210 to request that a particular action be remotely performed on a managed node 280.

### Secure Communications Channel

As already stated herein, a secure communications channel can be established, for example by communications channel generators 140, 240A, 240B, for communicating information between the managed node 280 to the management server 110, 210 for the purpose of monitoring the managed node 280 and/or for causing actions to be performed remotely on the managed node 280. More specifically, a secure communications channel can be used to support snapshots, dynamic re-allocation of resources, such as nodes, as already described herein, etc..

According to one embodiment, a secure communications channel between a management server and a managed node is established based on an initial authentication credential. According to one embodiment, the same initial authentication credential is used to establish secure communications channels between various management servers and various management nodes associated with an installation. Active authorization credentials can be used for establishing subsequent secure communications channels between management servers and management nodes where a different active authentication credential is used for each secure communications channel between each management server and the associated managed node.

According to one embodiment, the initial secure communications channel and the subsequent communications channel are the same communications channel that can be re-freshed with new authentication credentials. For example, the communications channel, which initially is based on an initial authentication credential 150, can be refreshed to be based on an active authentication credential 160 or can be refreshed based on regenerated active authentication credentials, as will become more evident.

According to one embodiment, a secure communication between a management server 110, 210 and a managed node 280 can be provided, among other things, for example, by:
uniquely identifying a managed node 280 to the management server 110, 210;
a managed node 280 only trusting the management server 110, 210 that manages the managed node 280 to remotely cause actions to be executed on the managed node 280;
a managed node 280 only communicating information back to the management server 110, 210 that managed node 280 for the purposes of monitoring the managed node 280;
and/or
using a secure communications channel to ensure the integrity and confidentiality of the information and/or actions communicated between the managed node 280 and the management server 110, 210.

Further, according to embodiments of the present invention, the method of providing secure communications between a management server 110, 210 and a managed node 280 is flexible. For example, different security technologies and different types of agents 222A, 222B can be used to provide a secure communications channel between the management server 110, 210 and the managed node 280, as will become more evident.

### Authentication Credentials

Authentication credentials can be used by one entity to authenticate another entity. An initial authentication credential 150, 250A, 250B can be used to establish, for example, a first secure communications channel between two entities, such as management server 110, 210 or managed node 280. The initial authentication credential 150, 250A, 250B can be unique for a particular installation, thus, protecting an installation from security breaches that are attempted from outside of the installation. This initial authentication credential 150, 250A, 250B can be installed on a management server 110, 210 and/or a managed node 280 by a factory that manufactured the management server 110, 210 and/or managed node 280, by an administrator, using a SAN or an out-of-band security transport, for example, as will become more evident. Further, an initial authentication credential 150, 250A can be installed first on the management server 110, 210, which in turn installs the initial authentication credential 250B on the managed node 280, for example, by remotely executing an action to install an image 220, which includes an initial authentication credential 150, 250A, on the managed node 280.

Initial authentication credentials 150, 250A, 250B can be used for establishing the first secure communications channel between the management server 110, 210 and the managed node 280. A second secure communications channel can be established between the management server 110, 210 and the managed node 280 based on a subsequent active authentication credential 160, 260A, 260B. The management server 110, 210 can use the first and/or the second secure communications channels to request that actions 274A be executed remotely on a managed node 280, for example.

The subsequent active authentication credential 160, 260A can be generated and communicated to the managed node 280 resulting in associating an active authentication credential 260B with the managed node 280, for example. A managed node 280 can communicate an active authentication credential 260B to a management server 210, for example, over the first secure communications channel that is based on the initial authentication credential 250B. Similarly, a management server 210 can communicate an active authentication credential 260A to a managed node 280, for example, over the first secure communications channel that is based on an the initial authentication credential 250A. According to another embodiment, the management server 210 or the managed node 280 can communicate their respective active authentication credentials 260A, 260B over a SAN or an out-of-band secure transport.

Further, as will become more evident, the active authentication credential 160, 260A, 260B can be re-generated, for example, based on a policy 212. For example, the policy 212 can include information instructing the management server 110, 210 or the managed node 280 to re-generate their respective authentication credentials 160, 260A, 260B at certain intervals of time. In this case, the management server 110, 210 can re-generate its active authentication credential 160, 260A as the policy 212 indicates and can communicate the regenerated active authentication credential 160, 260A to the managed node 280 which can replace its active authentication credential 260B with the re-generated active authentication credential 160, 260A. Alternatively, the management server 110, 210 can instruct the managed node 280 to re-generate its active authentication credential 260B as the policy 212 indicates. The managed node 280 can communicate its re-generated active authentication credential 260B to the management server 110, 210 which can replace its active authentication credential 160, 260A with the re-generated active authentication credential 260B.

According to one embodiment, public/private key pairs are used for providing secure communications channels and keys are used for implementing authentication credentials 160, 260A, 260B. For example, each protected communication can have a public/private key pair that is authenticated (and encrypted in the case of OpenSSH™ or SSL™) at each end of a connection between two entities. More specifically, the public and private keys can be related in such a way that the public key is used for encrypting communications and a private key can be used for decrypting the communications, as will become more evident. As is often the case, the public/private (asymmetric) key pair can be used to establish a symmetric encryption session (one-time use) key for improved encryption performance. Only the stable public/private key pair needs to be managed manually, as the session keys can be securely auto-generated (details of algorithms for generating symmetric session keys from an asymmetric encryption channel are widely deployed and well known in the art, so not described here)

Keys can be inputted to an entity, such as a management server 110, 210, 280 or managed node 280, using an electronic device. However, keys are rarely input directly by a user. Usually, key pairs are generated automatically and electronic copies of the public keys are copied between entities as needed.

### Policy

The active authentication credential 160, 260A can be regenerated, for example, based on a policy 212. The management server 110, 210 can determine based on the policy 212 that it is time to re-generate the active authentication credential 160, 260A. The management server 110, 210 can re-generate the active authentication credential 160, 260A and communicate the re-generated active authentication credential 160, 260A to the managed node 280 resulting in a re-generated active authentication credential 260B, for example. Further, a policy 212 can be used for determining what type of encryption and/or integrity checks to perform.

### Image

An image 220 can include whatever software that is or will be installed on a computer, such as a managed node 280. An image 220 can include an operating system, which contains an initial authentication credential 150, 250A and an agent 222A.

An image 220 can be communicated securely from a management server 110, 210 to a managed node 280 and installed on the managed node 280, for example, using an out-of-band network, such as a SAN, which prevents intruders on an local area network (LAN) from obtaining the initial authentication credential 250A associated with the image 220. A utility computing infrastructure provides the mechanisms for this out-of-band communication, such as a SAN provisioned as a key component of the infrastructure. If the intruders were able to obtain the initial authentication credential 250A, they would be able to imitate the management server 110, 210 that provided the image 220.

### Agent

An agent 222A, 222B can be software that is used for authenticating an entity, among other things. For example, an agent 222B that resides on a managed node 280 can be used for authenticating a management server 110, 210. As will become more evident, the agent 222B can use an authentication credential 250B, 260B as a part of authenticating an entity. For example, an agent 222B on a managed node 280 can use an initial authentication credential 250B or an active authentication credential 260B as a part of authenticating a management server 110, 210.

An agent 222A, 222B can be a non-proprietary agent associated with the operating system that is installed on a managed node 280, thus, providing an open and cost effective way of providing secure communications between a management server 110, 210 and a managed node 280. Although, a proprietary agent is not required by embodiments of the present invention, a proprietary agent can be used.

### Management Application

The management application 230 can be used for, among other things, generating an authentication credential 160, 260A as well as re-generating an authentication credential 160, 260A with an active authentication credential generator 130, for example. Further, management application 230 can be used for determining if a secure communications channel has been compromised and terminating the secure communications channel in the event that it has been compromised with a communications channel generator 140, for example.

### Trust Relationship

A first secure communications channel can be established between the management server 210 and a node 280 that the management server 210 manages. Active authentication credentials 160, 260A, 260B can be used for establishing a second secure communications channel between a management server 210 and a managed node 280.

According to one embodiment, a trust relationship 270A, 270B can include an active authentication credential 160, 260A, 260B, identity of entities, such as a managed node identifier 272A and/or a management server's identifier 272B, a trust level 276A, 276B, and a list of actions 274A, 274B. The management server 210's trust relationship 270A can identify (272A) the managed node 280 that the management server 210 has entered into trust relationship with. Similarly, the managed node 280's trust relationship 270B can identify (272B) the management server 210 that the managed node 280 has entered into a trust relationship with. The actions 274A associated with the management server 210's trust relationship 270A can be a list of the actions that the management server 210 can cause to be performed on the managed node 280. The actions 274B associated with the managed node 280's trust relationship 270B can be a list of actions that the managed node 280 allows to be performed on that managed node 280.

The managed node 280 trusts the management server 210 to a certain level 276B to monitor the managed node 280 and/or to cause actions to be performed remotely on the managed node 280. Although FIG. 2 depicts management server 210 and managed node 280 with only one trust relationship 470A, 470B, a management server 210 and a managed node 280 can have many trust relationships established with a multitude of entities. Further, a management server can have a different trust level, as well as a different active authentication credential, for each node the management server manages.

A trust relationship 270A, 270B, as will become more evident, can be setup between a management server 210 and a managed node 280 over a secure communications channel based on an initial authentication credential 150, 250A, 250B. The trust relationship 270A, 270B can be automatically re-established, for example, when the identity of a managed node 280 changes due to computing features, such as dynamic provisioning or re-provisioning of the managed node 280, a snapshot, etc.. For example, the active authentication credential 160, 260A can be re-generated, as will become more evident.

The trust relationship 270A, 270B can be re-validated on a regular basis, for example, and an active authentication credential 160, 260A can be re-generated based on a policy 212 as described herein. The communications channel can be terminated, as well as re-freshed, when the trust relationship 270A, 270B is broken, for example, due to utility computing features such as re-provisioning. The trust relationship 270A, 270B can be used for determining which actions can be performed remotely on a managed node 280.

According to one embodiment, more than one management server 210 can share a trust level and use the same authentication credentials for the purposes of being identified and/or authorized by managed nodes. For example, sharing a trust level and/or authentication credentials between management servers can be used for failover purposes and for moving the responsibility of managing certain managed nodes from one management server to another management server.

Managed nodes and management servers can share different trust relationships with associated levels of trust with different entities. For example, a management server A may have one level of trust with managed node B and another level of trust with managed node C. In this case, a managed node 280 can uniquely identify any other entity (e.g., other managed nodes and/or management servers) that attempts to communicate with the managed node 280.

Further, a managed node 280 can uniquely identify and/or authorize, for example using separate authentication credentials, other managed nodes and/or management servers. Since management servers can cause actions to be performed remotely on managed nodes, the managed nodes can use a high level of authentication, as will be described in regards to high security environments, of a management server based on the management server's identity, among other things, according to another embodiment. However, since managed nodes do not cause actions to be performed on management servers, there is more flexibility in managed nodes authenticating management servers.

According to one embodiment, a management server 210, 410 has a higher level of trust than a managed node 280, 480 so that a managed node 280, 480 can not cause actions to be performed on a management server 210, 410.

### Security Technology

Various security technologies can be used for creating the authentication credentials 150, 160, 270A, 260B, for ensuring secure communications channels, as well as for implementing the management application 230, among other things. The security technology used can be, among other things, open secure shell™ (Open SSH™), internet protocol security (IPsec), or secure sockets layer (SSL).

### Dynamic Provisioning System

According to one embodiment, a dynamic provisioning system 290, such as Hewlet Packard's utility data center™ (UDC™), can be used to dynamically provision and/or re-provisioned a managed node 280, storage that the managed node 280 uses, and the network infrastructure used for communicating between a management server 110, 210, the managed node 280 and the storage, among other things. Further, a dynamic provisioning system 290 can provision, re-provision and manage applications that reside on management servers 110, 210 and/or managed nodes 280. A dynamic provisioning system 290 can be used to provide information to a management server 110, 210, for example, about nodes 280 the management server 110, 210 manages, among other things.

### Operational Examples

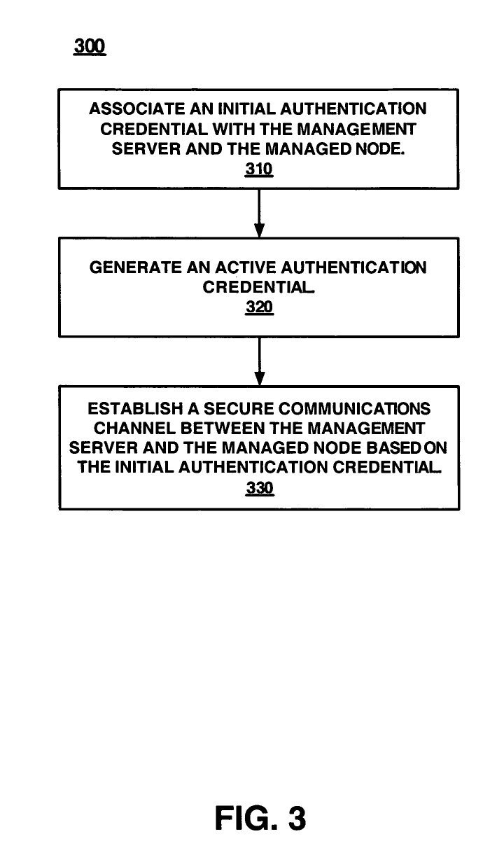

FIG. 3 depicts a flowchart 300 that is used to describe a method for securely communicating between a management server 210 and a managed node 280 according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the embodiments described by flowchart 300 can be implemented using computer-readable and computer-executable instructions which reside, for example, in computer-usable media of a computer system or like device.

For the purposes of illustration, the following description shall refer to the structures depicted in FIG. 2.

Step 310, an initial authentication credential is associated with the management server and the managed node. For example, an administrator or a factory, among other things, can install the management application 230 and/or an image 220 on the management server 210. The image 220 in turn includes an agent 222A and an initial authentication credential 250A. Further for the purposes of illustration, assume that the management server 210 causes the image 220 to be installed on the managed node 280 resulting in a copy of the agent 222B and a copy of the initial authentication credential 250B from the management server 210's image 220 being installed on the managed node 280.

Step 320, an active authentication credential is generated. For example, the active authentication credential generator 130 associated with the management server 210's management application 230 can generate the active authentication credential 260A.

Step 330, a secure communications channel is established between the management server and the managed node based on the initial authentication credential. For example, the communications channel generator 240 associated with the management server 210's management application 230 can use the initial authentication credential 250A to establish a secure communications channel with the managed node 280. The management server 210 can communicate the active authentication credential 270A to the managed node 280 over the secure communications channel. The management server 210 can also communicate the trust level 276A to the managed node 280, among other things. Alternatively, the managed node 280 can generate a trust relationship 270B with an associated trust level 276B based on an authentication credential 250B, 260B, for example.

The active authentication credentials, 260A, 260B can be used to establish subsequent communications channels for communicating between the management server 210 and the managed node 280. The subsequent communications channels can be used to communicate between the management server 210 and the managed node 280. For example, to cause actions to be run on the managed node 280 remotely, obtain information about the managed node 280 for the purposes of managing the managed node 280, etc.. A communications channel can be terminated, for example, based on information associated with a policy 212 or some event, such as detecting that the communications channel has been violated, a managed node 280 is being re-provisioned, or after the active authentication credential 260A has been communicated over the communications channel, among other things.

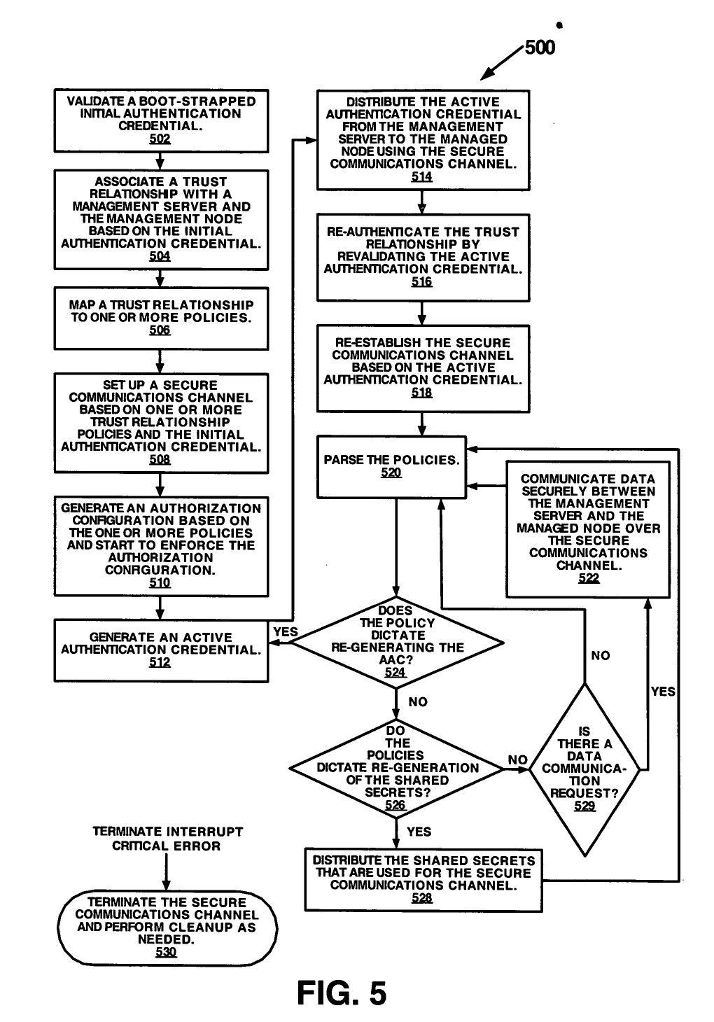

FIG. 5 depicts a flowchart 500 that is used to describe a method for securely communicating between a management server 210 and a managed node 280 according to embodiments of the present invention. Although specific steps are disclosed in flowchart 500, such steps are exemplary. That is, embodiments of the present invention are well suited to performing various other steps or variations of the steps recited in flowchart 500. It is appreciated that the steps in flowchart 500 may be performed in an order different than presented, and that not all of the steps in flowchart 500 may be performed. All of, or a portion of, the embodiments described by flowchart 500 can be implemented using computer-readable and computer-executable instructions which reside, for example, in computer-usable media of a computer system or like device.

For the purposes of illustration, the following description shall refer to the structures depicted in FIG. 2.

At step 502, a boot-strapped initial authentication credential is validated, according to embodiments of the present invention. An initial authentication credential 250A can be associated with a management server 210 and a managed node 280 in a similar manner already described herein in step 310, according to embodiments. The management server 210 and the managed node 280 can validate each other's respective initial authentication credentials 250A, 250B.

At step 504, a trust relationship 270A, 270B is associated with the management server 210 and the managed node 280 based on the initial authentication credential 250A, 250B. For example, the management server 210 can generate a trust relationship 270A, at least in part, based on its initial authentication credential 250A. More specifically, the management server 210 can use information for example from the DPS 290 to determine what managed nodes 280 it (e.g., 210) will establish a trust relationship 270A with and use the initial authentication credential 250A to determine the level of trust 276A it (e.g., 210) can have with those managed nodes 280. Similarly, the managed node 280 can generate a trust relationship 270B, at least in part, based on its initial authentication credential 250B. More specifically, if the management server 210 provided the initial authentication credential 250B to the managed node 280, the managed node 280 can use this fact to determine that a trust relationship 270B will be established with the management server 210 and then generate a level of trust 272B based on the initial authentication credential 250B.

At step 506, a trust relationship 270A, 270B can be mapped to one or more policies 212. At step 540, an authorization configuration can be generated based on the one or more policies 212 and the authorization configuration can start to be enforced. For example, what actions 274A a management server 210 can request to be performed on a remote system, such as a managed node 280, can be configured.

At step 508, a secure communications channel is setup based on one or more trust relationship policies and the initial authentication credentials. As a part of step 540, a secure communications channel can be established between the management server 210 and the managed node 280 based on the initial authentication credential 260A, 260B, in a similar manner already described herein under step 330. The secure communications channel can be used for communicating the active authentication credential 260A from the management server 210 to the management node or vice version with AAC 260B, for example, as already described herein.

At step 510, an authorization configuration can be generated based on the one or more policies 212 and the authorization configuration can start to be enforced. For example, what actions 274A a management server 210 can request to be performed on a remote system, such as a managed node 280, can be configured.

At step 512, an active authentication credential 260A, 260B is generated, in a similar manner already described herein under step 320.

At step 514, the active authentication credential 260A, 260B can be distributed from the management server 210 to the managed node 280 using the secure communications channel that was set up in step 508, according to one embodiment.

In step 516, the trust relationship 270A, 270B can be re-authenticated by revalidating the active authentication credential 260A, 260B.

In step 518, the secure communications channel can be re-established based on the active authentication credential 260A, 260B resulting in a refreshed communications channel.

In step 520 the policies 212 are parsed.

In decision box 524 a determination is made as to whether the policies 212 dictate re-generating the active authentication credentials 260A, 260B. If the policies 212 do dictate re-generation, then processing flows back to step 512, otherwise, processing flows to decision box 526.

At decision box 526, a determination is made as to whether the policies 212 dictate re-generation of the shared secrets used by the secure communications channel. If the policies 212 do dictate re-generation of the shared secrets, then processing flows to step 528; otherwise processing flows to decision box 529.

At step 528, the shared secrets are distributed and used for the secure communications channel, when for example, the shared secrets are re-keyed. Processing flows back to step 520 from step 528, according to one embodiment.

At decision box 529, a determination is made as to whether a data communication is requested. If a data communication is requested, the processing flows to decision box 522; otherwise, processing flows to step 520.

At step 522, data is communicated securely between the management server 210 and the managed node 280 over the secure communications channel. The refreshed communications channel (refer to the description of step 518) can be used for, among other things, communicating information between a management server 210 and a managed node 280. Examples of information include requested actions 274A, the status of the managed node 280, active authentication credentials 260A, 260B, and shared secrets, among other things. The active authentication credentials 260A, 260B may be communicated over the secure communications channel, for example, when they are re-generated, according to embodiments already described herein. The shared secrets may be communicated over the secure communications channel, for example, when the shared secrets are re-keyed.

At step 530, the secure communications channel that is based on the active authentication credential 260A, 260B is terminated and cleaned up as needed. Processing can flow to step 530 any time during the execution of steps 512 through 529, for example due to a critical error. The communications channel can be terminated, for example, based on information associated with a policy 212 or some event, such as detecting that the communications channel has been violated, a managed node 280 is being re-provisioned, or after the active authentication credential 260A, 260B has been communicated over the communications channel, among other things. Processing can flow to step 512 for example after the secure communications channel is terminated at step 530.

Although the above flowchart 500 illustrated embodiments of the present invention by describing decision box 526 following decision box 524 and decision box 529 following decision box 526, the order of these decision boxes (524, 526, 529) can be processed in any order.

### A System Implemented with Open SSH™

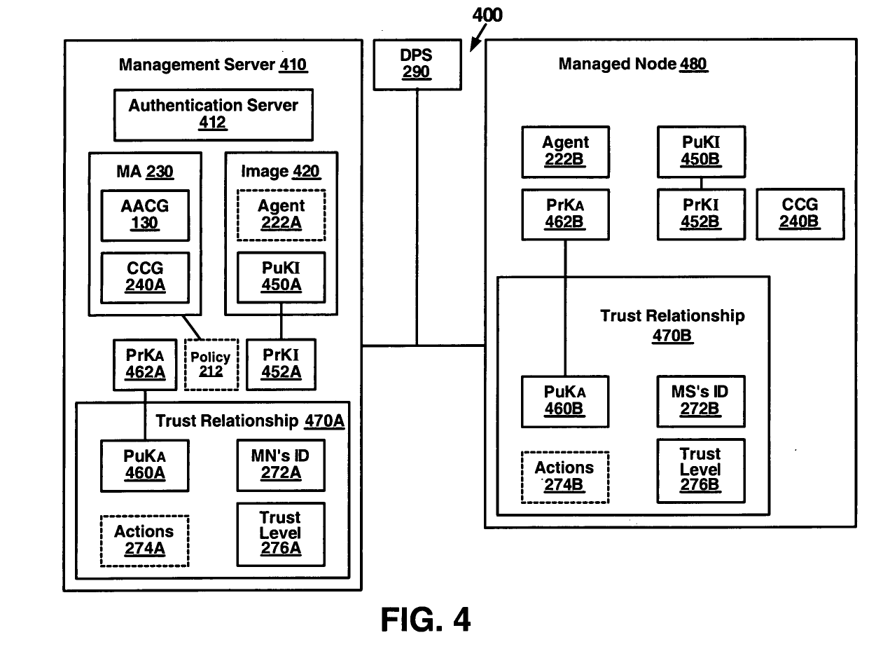

FIG. 4 is a block diagram of an exemplary software system for securely communicating between a management server and a managed node using the open SSH™ security technology, according to embodiments of the present invention. The blocks in FIG. 4 can be arranged differently than as illustrated, and can implement additional or fewer features than what are described herein. Further, the features represented by the blocks in FIG. 4 can be combined in various ways.

FIG. 4 depicts a management server 410, a managed node 480 that is managed by the management server 410,, and a dynamic provisioning system 290 that can provision the managed node 480, as already described herein. The management server 410 includes management application 230, an optional image 420, an optional agent 222A, an initial public key 450A (PuKi) and its associated initial private key 452A (PrKi), an optional policy 212, a trust relationship 470A, an active public key 460A (PuKa) and its associated active private key 462A (PrKa), optional actions 274A, a managed node identifier 272A, a trust level 276A, and a communications channel generator 240 (CCG). The optional agent 222A and initial public key 450A can be a part of the optional image 420. The active public key 460A (PuKa), the optional actions 274A, the managed node identifier 262A and the trust level 276A can be associated with the trust relationship 470A. The management application 230 can include an active authentication credential generator 130 and a communications channel generator 240A. The initial public key 450A (PrKi) is an example of an initial authentication credential 250, according to one embodiment, and the active public and/or private keys 462A, 460A (PuKa, PrKa) is an example of an active authentication credential 250A, according to another embodiment.

According to one embodiment, the image 420 is an example of an initial authentication credential associator 120. According to another embodiment, an input device or a generalized user interface (GUI) associated with the computer that the management server 410 executes on are examples of an initial authentication credential associator 120 where the input device or the GUI receives an initial public key 450A and stores it in memory.

The managed node 480 can include an agent 222B, an initial public key 450B (PuKi) and its associated initial private key 452B (PrKi), trust relationship 470B, a management server's identifier 272B, a trust level 276B, an active public key 460B (PuKa) and its associated active private key 462B (PrKa), and a communication channel generator 240B. The trust relationship 470B can include the active public key 460B (PuKa), the management server's identifier 272B, and the trust level 276B. An agent 222B can be a non-proprietary agent associated with the operating system that is installed on a managed node 480. According to one embodiment, the initial public key 450B (PuKi) is an example of an initial authentication credential 250B, and according to another embodiment, the active public key 460B (PuKa) is an example of an active authentication credential 260B.

As already stated herein, public and private keys can be related in such a way that the public key is used for encrypting communications and a private key can be used for decrypting the communications. For example, public keys 450A, 460A, 450B, 460B are paired with the respective private keys 452A, 462A, 452B, 462B. Further, the management server 410 can use public keys 450A, 460A (PuKi, PuKa) to encrypt communications that it (e.g., 410) transmits to managed node 480. Similarly, managed node 480 can use public keys 450B, 460B (PuKi, PuKa) to encrypt communications that it (e.g., 480) transmits to management server 410. Management server 410 can use the private keys 452A, 462A that are paired with the respective public keys 450A, 460A to decrypt communications that it (e.g., 410) receives from the managed node 480. Similarly, the managed node 480 can use the private keys 452B, 462B that are paired with the respective public keys 450B, 460B to decrypt communications that it (e.g., 480) receives from the management server 410.

### An Operational Example Using a System Implemented with Open SSH™

The following describes an embodiment for securely communicating between a management server 410 and a managed node 480 using the open SSH™ security technology. For example, as will become more evident, public and/or private keys can be used to provide a secure communication between the management server 410 that is based on a trust relationship 470A, 470B between the management server 410 and the managed node 480. Further, various SSH mechanisms (such as an SSH server), an SSH identity file, an authorized keys file, an SSH configuration file, and/or a known hosts file can be used as a part of providing the secure communication using the SSH technology.

The SSH server can be used for identifying the managed node 480 to other managed nodes and/or management servers. The SSH server can be used to trust a public key, for example, by configuring a public key, such as PuKi 450B or PuKa 460B, in the authorized keys file.

For the purposes of illustrating the description of the embodiment that uses SSH technology, it shall be assumed that the SSH identity file, and the SSH configuration file are associated with the management server 410. Further, it shall be assumed that the SSH server, authorized keys file and the known hosts file are associated with the managed node 480, and that the managed node 480 is a managed server.

In step 310, an initial authentication credential is associated with the management server and the managed node. For example, assume that initially the management server 410 includes management application 230, and an image 420, which in turn includes an agent 222A and an initial authentication credential 250 in the form of an initial public key 450A (PuKi). Also assume, that the management server 410 causes the image 420 to be installed on the managed node 480 resulting in copies of the agent 222B and the initial public key 450B (PuKi) being installed on the managed node 480.

The image 420, which resides on the management server 410 and which can be installed on a managed node 480, can also be configured with StrictHostKeyChecking (either as “ask” or “yes) in the SSH configuration file, which can reside on the management server 410, so that a different managed node 480 is never trusted as a management server, automatically at any time, for example.

Further, if it is determined that the management server 410's IP address (e.g., the IP address that the managed node 480 uses to reference the management server 410) will be shared by all management servers during normal operations and fail over, then the CheckHostIP can be enabled in the SSH configuration file (e.g., /opt/sh/etc/ssh_config file) to prevent DNS spoofing.

The initial public key 450A, 450B (PuKi) can be used to establish initial communications between a managed node 480 and a management server 410. This initial public key 450A can be re-configured, as already described herein, with a different public key, such as the active public key 460A, for example, when the management server 410 is first able to cause an action to be remotely executed on the managed node 480. An initial public key 450A, 450B (PuKi) can be associated with the managed node 480 and/or the management server 410 at a factory (or equivalent) without compromising individual server core deployments.

If a DHCP environment is associated with a system 400, then CheckHostIP can be disabled in the SSH configuration file so that changes to the managed node 480's IP address will not break the active authentication credential (e.g., PuKa 460A, 460B) established between the managed node 480 and the management server 410. Also incase of a dynamic provisioning system 290, such as UDC, disabling CheckHostIP may be necessary due to the dynamic address allocation. However, DNS spoofing of the management server 410 can still be prevented since a DNS server for a managed node 480 can be provided locally on a management server 410.

In step 320, an active authentication credential is generated. For example, the management server 410 can dynamically generate the active public-private key pair 462A, 460A (PuKa, PrKa), when the management server 410 boots up the first time, for example. The active public private key pair 462A, 460A can be configured in an SSH identity file.

For all subsequent reboots of managed nodes, the management server 410 can re-generate the active public private key pair 462A, 460A (PuKa, PrKa), as well as re-configure the active public private key pair 462A,460A (PuKa, PrKa) in the SSH identity file, for example when the management node 480 detects that its identity has changed. Detecting that the identity has changed can be done, for example, by caching the management node 480's present “fully qualified” DNS name and checking whether the “fully qualified” DNS name has changed during a boot up, for example, by comparing the “fully qualified” DNS name with the local hostname query that is fully qualified. If the identity has changed,then the active public private key pair 462A, 460A (PuKa, PrKa) can be regenerated. The IP address of the management node 480 can change, due to possible DHCP environments, according to one embodiment, the IP address may not linked to the SSH identity to regenerate the active public private key pair 462A, 460A (PuKa, PrKa). According to one embodiment, re-generating the active public private key pair 462A, 460A (PuKa, PrKa) is only performed for medium and low security environments,which are discussed hereinafter.

A change in identity can happen either due to manual changes (for example in the case of migrating systems across domains) or due to utility computing processes such as snapshots (e.g., a utility that uses image 420 to provision managed nodes with the same application requirements that have different identities). In either case, the active authentication credential established may need to be re-established, and hence active public private key pair 462A, 460A (PuKa, PrKa) can be automatically re-generated before provisioning the image 420 for a new managed node that has a different identity, for example, than the managed node 480.

The management server 410 can be notified when the managed node 480 is fully initialized, for example, by installing the image 420 on the managed node 480.

In step 330, a secure communications channel is established between the management server and the managed node based on the initial authentication credential. For example, the management server 410 can use the initial public key 450 (PuKi) to establish a secure communications channel with the managed node 480 to enable communication of the active authentication credential (e.g., PuKa 460A) to the managed node 480. According to one embodiment, the management server 410 can cause the active public key 460B (PuKa) to be configured on the managed node 480 as soon as the managed node 480 and the management server 410 are able to communicate, for example. In this case, the management server 410 can use the initial public key 450A (PuKi) to authenticate itself with the managed node 480, for example, when the management server 410 first communicates with the managed node 480. Further, the management server 410 can execute commands to accomplish the following:
1) Install the active public key 460A (PuKa) on the managed node 480, so that the managed node 480 trusts the management server 410 to use the active private key 462A (PrKa) for future communication between the management server 410 and the managed node 480. As a part of installing:
   a) Configure the active public key 460B (PuKa) into the global known hosts file. Alternatively, the active public key 460B (PuKa) can be configured into the known hosts file of the user account associated with management server 410's SSH.
   b) Overwrite the initial public key 450B (PuKi) in the authorization keys file on the managed node 480 with the active public key 460B (PuKa), so that the managed node 480 trusts the management server 410 that uses active private key 462A (PrKa) for future communication.
2) Confirm that the SSH server is configured for StrictHostKeyChecking and/or CheckHostIP (if meeting the conditions mentioned earlier), according to one embodiment.
3) Configure the authorized key files to allow only specific actions from the management server 410, according to one embodiment. This can be used to mitigate the risk that the managed node 480 will have to allow the management server 410 to run commands as root. Although this illustration referred to an authorized key files, any mechanism for specifying the specific actions that a management server 410 can initiate can be used, such as a captive login account.

According to one embodiment, the management server 410 can be configured in the SSH identity file with the private key equivalent 452A (PrKi) of the initial public key 450A (PuKi) as well as the private key equivalent 462A (PrKa) of the active public key 460A (PuKa), for example. According to one embodiment, the management server 410 can cause the active public key 460B (PuKa) to be configured on the managed node 480 as soon as the managed node 480 and the management server 410 are able to communicate.

As a part of establishing a secure communications channel in step 330, the management server 410 can authenticate the managed node 480's identity. Authenticating the managed node 480's identity can be accomplished flexibly with a high, medium, or low security environment, as described below:

For high security environments:
The management server 410 can query a centralized authentication server 312 that has installed, either manually or automatically, private-public key pair credentials 460A on managed node 480 to uniquely identify the managed node 480. If the managed node 480 passes identification, then the public key 460B is accepted and configured in the known hosts file.
A security authenticated SSH session can be used for communicating from the managed node 480 to the management server 410. In this case the managed node 480 can be authenticated using the methodology described above for high security environments. According to one embodiment, only the commands that are used for communicating data from the managed node 480 to the management server 410 are configured in the authorized keys file. According to another embodiment, captive login accounts can be configured in SSH™ to restrict commands to a limited set and only authorized keys are allowed to access the restricted accounts. The authorized keys file can be pre-configured with the active public key 460B (PuKa) that the management server 410 already uses.
Actions may not be generic, but instead can be “wrapped” into uniquely identifiable commands so that, for example, the calling node can be easily identified, according to yet another embodiment. More specifically, a touch command can be wrapped into a touchHost1 that identifies Host1 and the touchHostl can be configured in the authorized keys file, which is associated with Host1, as an authorized action of Host1. Further, the commands are used only for communicating from the managed node 480 to the management server 410, according to still another embodiment.

For medium security environments:
The threat that one managed node (not shown) can spoof another managed node 480, that the management server 410 is communicating with, can be mitigated by using virtual local area networks (VLANs) and host based firewall IP layer anti-spoofing, for example, by checking the source IP address of the packet belonging to the IP address subnet allocated to the specific VLAN. By using VLANs and by assuming that the systems associated with the VLAN are trusted, the management server 410 can trust a public key 450B (e.g., PuKi) when, for example, the managed node 480 is first being initialized. This can be implemented either by serializing the addition of the managed node 480's public key 450B to the known hosts file and then enabling StrictHostKeyChecking again or by keeping the StrictHostKeyChecking enabled (with the ‘ask’ option, for example) and ensuring that the program that accepts the provided public key 450B automatically.
A security authenticated SSH session can be used for communicating from the managed node 480 to the management server 410. In this case the managed node 480 can be authenticated using the methodology described above for medium security environments mechanism. As already described with regards to a high security environment, actions may not be generic, but instead can be “wrapped” into uniquely identifiable commands so that, for example, the managed node 480, that communicates with the managed node 480, can be easily identified, according to yet another embodiment.

For low security environments:
StrictHostKeyChecking can be disabled on the management server 410 so that managed node 480's keys 450B, 460B (PuKa, PuKi)) get added/over written in the known host keys file transparently.
A tcp session can be used for communicating from a managed node 480 to the management server 410. A tcp session from the managed node 480 to the management server 410 can be anti-spoofed using a combination of VLAN based segregation, host based IP layer anti-spoofing, and application layer anti-spoofing that uses a custom listener, for example. The custom listener can check the application layer identity with the telnet socket IP address and expose interfaces that can only be used for communicating data from the managed node 480 to the management server 410, for example.

The methodology described above for high security and medium security environments can provide confidentiality and integrity, along with improved authentication. However, if the SSH server authorization can be dynamically configured, for example, at the time the active public key 460B (PuKa) is added to the known hosts file, so that only the commands which are used for communicating data from the managed node 480 to the management server 410 are configured in the authorized keys file; then a low security environment can provide adequate confidentiality, integrity, and authentication, according to one embodiment.

The management server 410 can re-generate the active key pair 462A, 460A (PuKa, PrKa) and then cause the existing public key 460B (PuKa) that is configured in the known hosts file and/or the authorized keys file to be overwritten. The re-generated active public key 460A, 460B (PuKa) can be used for identifying the management server 410. This type of action can be limited using the authorized keys file. The re-generated active public key 460A, 462A pair (PuKa, PrKa) can be configured in the SSH identity file.

As already stated herein, active authentication credentials, such as those provided by active public and/or private keys 460A, 462A can be re-generated. Detection of changes to IP addresses (in the case of a non-DHCP environment) or to the local non-qualified hostname (for special use cases) can be used for triggering the re-generation of the active key pair 460A, 462A (PuKa, PrKa), for example.

Ordinarily, previous active public keys can be tracked in the management server 410's SSH identity file. These previous active public keys can be used to support previous images for old managed nodes that have been temporarily idled, standbyed, or snap-shot for later use. However, in order to avoid tracking previous active public keys in the management server 410's SSH identity file, the management server 410's initial public key 450A (PuKi) can be used instead of the management server 410's active public key 460A (PuKa) for establishing secure communications, for example, in order to communicate with a newly provisioned managed node that was created with a snapshot image or with a managed node 480 that was activated after being idled or standbyed for some time.

According to one embodiment, the management server 410's active public key 460A (PuKa) is replaced with the management server 410's initial public key 450A (PuKi), in this case. As already stated, the active public key 460A (PuKa) can be initially created (referred to herein as the first active public key) and re-generated (referred to as subsequent active public keys). Instead of using the management server 410's initial public key 450A (PuKi) to avoid tracking previous active public keys. Alternatively, the management server 410's first active public key can be used. In either case, as already described herein, the active public key 460A (PuKa) can be re-generated and used to establish for subsequent secure communications channels.

Certain processes and steps of the present invention are realized, in one embodiment, as a series of instructions (e.g., software program) that reside within computer readable memory of a computer system and are executed by the system as described by flowcharts 300, 400, 500. When executed, the instructions cause the computer system to implement the functionality of the present invention as described below.

### CONCLUSION

Diffie-Hellman can be used to establish a shared level of trust between entities in an un-trusted network, for example, where entities do not have sufficient information to know what entities they are communicating with. Even after a secure communications channel has been established using Diffie-Hellman, the entities using the secure communications channel do not know what entities they are communicating with.

However, a management server 210 and a managed node 280 can use information from a dynamic provisioning system 280 to accurately identify each other. For example, a dynamic provisioning system 290 provides enough information to the management server 210 and managed node 280 so that initial authorization credentials 250A, 450A can be communicated from a management server 210, 410 to a managed node 280, 480, for example using an image 220, 420, without the complexity involved with Diffie-Hellman.

Further, embodiments of the present invention allow the initial authorization credentials 150, 250A, 450A to be distributed automatically, thus, avoiding costly manual intervention.

The use of proprietary software can be avoided by using, among other things, management application 230 and/or non-proprietary agents 222A, 222B, thus, providing open, flexible, and cost effective secure communications between a management server 210 and a managed node 280. Further, many conventional solutions did not provide adequate security. For example, proprietary software does not adequately handle dynamic reallocation of resources, for example, using snapshots. In this case, active authentication credentials could be replicated, and therefore, not used as intended. Further, with conventional solutions an active authentication credential may not be revalidated at regular intervals, for example, because the active authentication credential was not inline with management platform logic.

### Extensions and Alternatives

Although embodiments of the present invention have been described in the context of individual systems 110, 210, 280, 410, 480, embodiments of the present invention can be generalized to networks.

Although certain embodiments of the present invention were described using a managed node, the managed node can be a managed server.

Embodiments of the present invention are thus described. While the present invention has been described in particular embodiments, it should be appreciated that the present invention should not be construed as limited by such embodiments, but rather construed according to the following claims.

1. A method of securely communicating between a management server and a managed node associated with a dynamic provisioning system, the method comprising:
associating an initial authentication credential with the management server and the managed node, wherein the managed node can be provisioned by the dynamic provisioning system;
generating an active authentication credential; and
creating a first secure communications channel with the initial authentication credential, wherein first secure communications channel is between the management server and the managed node and wherein the first secure communications enables the communication of the active authentication credential between the managed node and the management server.

2. The method as recited in claim 1, further comprising:
using a non-proprietary agent that can authorize the management server.

3. The method as recited in claim 1, further comprising:
creating a refreshed secure communications channel using the active authentication credential; and
using the refreshed secure communications channel to communicate between the management server and the managed node.

4. The method as recited in claim 1, wherein the using the refreshed secure communications channel to communicate between the management server and the managed node further comprises:
using the refreshed communications channel to provide a communication between the management server and the managed node, wherein the communication is selected from a group consisting of an action to be performed and information to be obtained.

5. The method as recited in claim 1, further comprising:
re-generating the active authentication credential.

6. The method as recited in claim 1, further comprising:
creating the initial authentication credential and generating the active authentication credential for a network protocol using an authentication credential.

7. The method as recited in claim 1, further comprising:
establishing a trust relationship between the management server and the managed node, wherein the trust relationship specifies a level of trust between the management server and the managed node.

8. The method as recited in claim 1, further comprising:
communicating the active authentication credential between the management server and the managed node over the first secure communications channel.

9. A management server for securely communicating with a managed node associated with a dynamic provisioning system, the management server comprising:
an initial authentication credential associator for associating an initial authentication credential with the management server and the managed node, wherein the managed node can be provisioned by the dynamic provisioning system;
an active authentication credential generator for generating an active authentication credential; and
a communications channel generator for creating a first secure communications channel with the initial authentication credential, wherein the first secure communications channel is between the management server and the managed node and wherein the first secure communications enables communication of the active authentication credential between the managed node and the management server.

10. The management server of claim 10, wherein the initial authentication credential associator is an image that can be used to associate a non-proprietary agent with the managed node.

11. The management server of claim 10, wherein the non-proprietary agent can authorize the management server to communicate with the managed node.

12. The management server of claim 9, wherein the active authentication credential generator re-generates the active authentication credential.

13. The management server of claim 12, further comprising:
a policy, wherein the active authentication credential generator re-generates the active authentication credential based on the policy.

14. The management server of claim 9, further comprising:
a list of actions, wherein the management server can cause the actions to be performed on the managed node.

15. The management server of claim 9, further comprising:
a trust relationship that can be established between the management server and the managed node, wherein the trust relationship specifies a level of trust between the management server and the managed node.

16. A computer-usable medium having computer-readable program code embodied therein for causing a computer system to perform a method of securely communicating between a management server and a managed node associated with a dynamic provisioning system, the method comprising:
associating an initial authentication credential with the management server and the managed node, wherein the managed node can be provisioned by the dynamic provisioning system;
generating an active authentication credential; and
creating a first secure communications channel with the initial authentication credential, wherein first secure communications channel is between the management server and the managed node and wherein the first secure communications enables the communication of the active authentication credential between the managed node and the management server.

17. The computer-usable medium as recited in claim 16, wherein the computer-readable program code embodied therein causes a computer system to perform the method, and wherein the method further comprises:
using a non-proprietary agent that can authorize the management server.

18. The computer-usable medium as recited in claim 16, wherein the computer-readable program code embodied therein causes a computer system to perform the method, and wherein the method further comprises:
creating a refreshed secure communications channel using the active authentication credential; and
using the refreshed secure communications channel to communicate between the management server and the managed node.

19. The computer-usable medium as recited in claim 16, wherein the using the refreshed secure communications channel to communicate between the management server and the managed node and wherein the computer-readable program code embodied therein causes a computer system to perform the method, and wherein the method further comprises:
using the refreshed communications channel to provide a communication between the management server and the managed node, wherein the communication is selected from a group consisting of an action to be performed and information to be obtained.

20. The computer-usable medium as recited in claim 16, wherein the computer-readable program code embodied therein causes a computer system to perform the method, and wherein the method further comprises:
re-generating the active authentication credential.

21. The computer-usable medium as recited in claim 16, wherein the computer-readable program code embodied therein causes a computer system to perform the method, and wherein the method further comprises:
creating the initial authentication credential and generating the active authentication credential for a network protocol using an authentication credential.

22. The computer-usable medium as recited in claim 16, wherein the computer-readable program code embodied therein causes a computer system to perform the method, and wherein the method further comprises:
establishing a trust relationship between the management server and the managed node, wherein the trust relationship specifies a level of trust between the management server and the managed node.

23. The computer-usable medium as recited in claim 16, wherein the computer-readable program code embodied therein causes a computer system to perform the method, and wherein the method further comprises:
communicating the active authentication credential between the management server and the managed node over the first secure communications channel.
